(19) United States
(12) Patent Application Publication
(10) Pub. No.: US 2006/0289177 A1
(43) Pub. Date: Dec. 28, 2006

(54) Device for filling carroting holes in a lawn

(76) Inventor: Jean-Claude Cuadrado, Villeneuve de la Raho (FR)

Correspondence Address: JEROME D. JACKSON (JACKSON PATENT LAW OFFICE), 211 N. UNION STREET, SUITE 100, ALEXANDRIA, VA, 22314, US

(21) Appl. No.: 10/546,270

(22) PCT Filed: Feb. 27, 2004
(86) PCT No.: PCT/FR04/00478

§ 371 Date: Aug. 22, 2005

(30) Foreign Application Priority Data
Mar. 24, 2003 (FR) 03/03587

(51) Int. Cl. A01B 45/02

(52) U.S. Cl. 172/21

(57) ABSTRACT

The invention relates to a device for filling carroting holes, which are made in a lawn, with the aid of sand mixed with fertilizers. The inventive device comprises a plurality of fixed elements (1), of brushes or blades made of rubber disposed on a frame (2) which is fixed to the lifting arm of a motorized rolling device. The invention is essentially characterized in that the elements (1) are disposed in at least two rows (R1) et (R2) which are transversal in relation to the direction of advancement (F) of the device, whereby the first row (R1) consists of two joined center elements (10) and (11) which are disposed in a V-shape and at least two distinct side elements (12) and (13) which are disposed on each side of the center elements (10, 11) and the second row (R2) comprises two joined center elements (14) and (15) which are disposed in a V shape and at least two distinct side elements (18, 19) which are disposed on each side of the center elements (14, 15).

### FIELD OF THE INVENTION

The invention relates to a device for filling carroting holes, made in a lawn, using sand mixed with fertilizers; the aforementioned device being of the type including a plurality of fixed elements, of brushes or blades made of semi-rigid rubber, arranged on a frame so as to cover, continuously the totality of the width of the sanded work surface; the aforementioned fixed elements being arranged on at least two rows, traverse in relation to the direction of movement of the device; the aforementioned chassis being fixed to the lift arms of a motorized rolling vehicle.

### TECHNICAL BACKGROUND

The known devices of the type in question are generally of two categories:
those using a specific arrangement of fixed linear or cylindrical rotating brushes, perpendicular or inclined in relation to the direction of advancement, which lack efficiency and requires several passages to fill the carroting holes with as a consequence induces wearing of the lawn;
those using an arrangement of brushes mounted on rotating arms which, besides the preceding disadvantages, also present those tied to throwing of the sand outside of the work zone and the lack of homogeneity of filling.

The closest technical field is set out in the patent EP1356720, which describes a device adapted to be coupled to a vehicle and provided with modules arranged on 3 rows and intended to effectuate lawn treatment operations.

Each module includes brush elements inclined according to a fully determined arrangement:
the first row includes two joined central elements, V-shaped, associated with lateral elements parallel to the opposing central elements;
the second row includes only lateral elements parallel to the corresponding lateral elements of the first row.

Such an arrangement does not permit achieving a high filling rate of the carroting holes as well as a regular and uniform filling distribution.

In fact, it does not generate back and forth side movement and the central part remains unswept from the second row on with the formation of longitudinal contour ridges (windrows) as another consequence.

### SUMMARY OF THE INVENTION

The invention concerns therefore a device that eliminates the disadvantages mentioned above and is characterized essentially by its efficiency in rate and speed of filling carroting holes from the back and forth oblique movement that it gives to the sand on the entire width of the device in the course of functioning.

The device according to the invention is characterized essentially in that:
a) the first row includes two joined central elements, arranged in V-shape, adapted to obliquely displace the sand situated on their trajectory in the direction of the free ends of the aforementioned central elements and associated with at least two first distinct lateral elements arranged on each side of the aforementioned central elements and adapted for, on the one hand, recuperating and obliquely displacing, in opposite direction, the part of the sand displaced previously by the aforementioned central elements and not dumped into the carroting holes situated on the passage of the aforementioned lateral elements, and, on the other hand, to obliquely displace, in the aforementioned direction, the sand situated on the part of the trajectory ranging between the free ends of the aforementioned central elements and the exterior ends of the aforementioned lateral elements;
b) the second row, includes two joined central elements, arranged in V-shape, adapted for recuperating and obliquely displacing, in the direction of the free ends of the aforementioned elements, in other words in the opposite direction from that resulting from the action of the lateral elements of the first row, the part of the sand not dumped into the carroting holes situated on the passage of the aforementioned elements.

### PRESENTATION OF THE FIGURES

The characteristics and the advantages of the invention will appear more clearly with the reading of the detailed description that follows of at least one preferred mode of implementation of it given by way of non limiting example and represented in the annexed drawings.

In the drawings:

FIG. 1 is a bottom view of the device according to the invention representing only the brush or blade elements;

FIG. 2 is a top view of the aforementioned device representing only the connection means from the frame to the lift arms and the rolling means of the aforementioned frame.

FIG. 3 is a profile view of the articulated connecting rod.

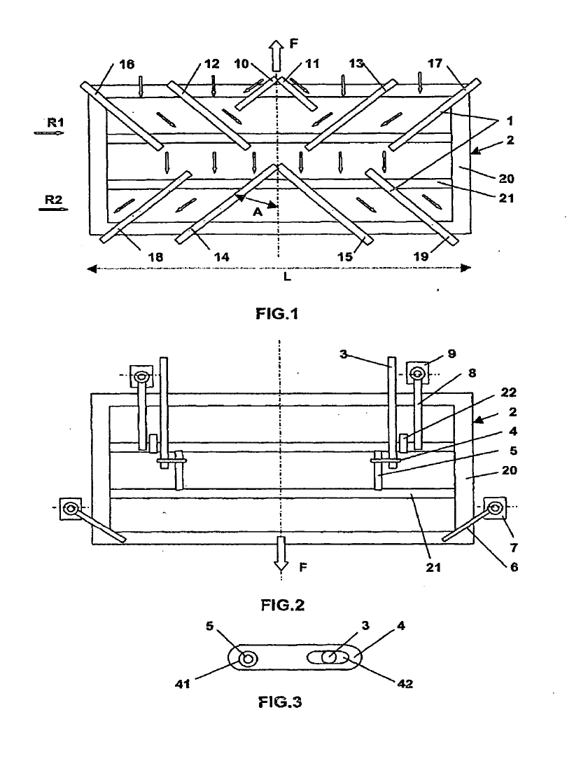

### DETAILED DESCRIPTION OF THE INVENTION

The device represented in the figures is intended for filling carroting holes, made in a lawn, using sand mixed with fertilizers.

It is of the type including a plurality of fixed elements (1), of brushes or semi-rigid blades made of rubber, arranged on a frame (2) so as to cover, continuously, the total width (L) of the sanded work surface; the aforementioned fixed elements (1) being arranged in at least two rows (R1) and (R2), transverse in relation to the direction of advancement (F) of the device; the aforementioned frame being fixed to the lift arms (3) of a rolling motorized vehicle.

According to the basic characteristics of the invention:
a) the first row (R1) includes two joined central elements (10) and (11), arranged in V-shape, adapted to obliquely displace the sand situated on their trajectory in the direction of the free ends of the aforementioned central elements and associated with at least two first distinct lateral elements (12) and (13) arranged on each side of the aforementioned central elements (10, 11) and adapted for, on the one hand, recuperating and obliquely displacing, in opposite direction, the part of the sand previously displaced by the aforementioned central elements and not dumped into the carroting holes situated on the passage of the aforementioned lateral elements, and, on the other hand, obliquely displacing, in the aforementioned direction, the sand situated on the part of the trajectory ranging between the free ends of the aforementioned central elements (10, 11) and the exterior ends of the aforementioned lateral elements (12, 13);
b) the second row (R2), includes two central joined elements (14) and (15), arranged in V-shape, adapted for recuperating and obliquely displacing, in the direction of the free ends of the aforementioned elements, in other words in the opposite direction from that resulting from the action of the lateral elements (12, 13) of the first row (R1), the part of sand not dumped into the carroting holes situated on the passage of the aforementioned elements.

The central V-shaped elements, pointing forward, permit, furthermore, an auto centering of the device in the course of its travel.

According to additional characteristics of the invention:
the first row (R1) can include two distinct lateral elements (16, 17) arranged on each side of the lateral elements (12, 13) and adapted for, on the one hand, recuperating and obliquely displacing, in the same direction, the part of the sand previously displaced by the aforementioned lateral elements (12, 13) and not dumped into the carroting holes situated on the part of the trajectory ranging between the exterior ends of the lateral elements (12, 13) and the exterior ends of the lateral elements (16, 17);
the second row (R2) can include two distinct lateral elements (18, 19) arranged on each side of the central elements (14, 15) and adapted for recuperating and obliquely displacing, in the opposite direction, the part of the sand previously displaced by the lateral elements (12, 13) and (16, 17) and not dumped in the carroting holes situated on the passage of the aforementioned elements.

The rows (R1) and (R2) could include V-shaped joined elements arranged in the same direction as the central elements (10, 11) and (14, 15) and of the lateral elements arranged in the same direction as the lateral elements (12, 13) and (18, 19) or even in opposing directions.

According to the preferred implementation of the invention, all the elements (1) form, with the axis (A) of the frame (2), an angle of 45° and are symmetrical in relation to the aforementioned axis.

According to the particularities of implementation of the invention:
the frame (2) is connected to each lift arm (3) by means of a connecting rod (4) provided, on the frame side, with a pierced joint (41) traversed by an axel (5) connected to cross pieces (21) of a sash (20) of the aforementioned frame, and, on the lift arm side, with a longitudinal opening (42) capable of permitting the longitudinal displacement of the end of the aforementioned lift arm in order to compensate for the deviations of movement of the machine and to maintain the brushes always stuck flat to the ground without loss of adherence;
the frame (2) includes, laterally, at the front, at the exterior of the work zone (L), wheels (7) connected to offset arms (6);
the frame (2) includes, at the rear, wheels (9) connected to support arms (8);
the wheels (7) and (9) are pivotable with respect to their support axis and are adjustable in height with respect to the frame in order to adjust the working height of the elements (1).

The frame (2) also includes:
on the top, bent bars adapted for coinciding with the antioscillatory stops of the tractor vehicle;
at the back, two chains that are engaged on each lift arm in the aim of stabilizing the device.

The ends of the brushes, or blades, are positioned with a slight overlap.

According to an advantageous implementation of the invention, the frame (2) is fixed to the lift arms of a standard commercial lawnmower instead of the carrying frame of the cutting tools.

The arrangement of the brushes inducing a back and forth movement can also be used for standing back up strands of grass that have been set down by successive passages of rolled machines.

Of course, the invention is not limited to the described and represented implementation modes for which one will be able to provide for other variations in:
the number, the shapes and arrangement of the brushes or of the blades
the type of carrier of the frame of the device; and the extension to other applications.

1-10. (canceled)

11. A device for filling carroting holes, made in a lawn, using sand mixed with fertilizers, of the type including a plurality of fixed elements, of brushes or semi-rigid blades made of rubber, arranged on a frame so as to cover, continuously, the total width of the sanded work surface; the aforementioned fixed elements being arranged in two rows, transverse in relation to the direction of advancement of the device; the aforementioned frame being fixed to the lift arms of the rolling motorized vehicle characterized in that: a) the first row includes two joined central elements, arranged in V-shape, adapted to obliquely displace the sand situated on their trajectory in the direction of the free ends of the aforementioned central elements and associated with two first distinct lateral elements arranged on each side of the aforementioned central elements and adapted for, on the one hand, recuperating and obliquely displacing, in opposite direction, the part of the sand previously displaced by the aforementioned central elements and not dumped into the carroting holes situated on the passage of the aforementioned lateral elements, and, on the other hand, obliquely displacing, in the aforementioned direction, the sand situated on the part of the trajectory ranging between the free ends of the aforementioned central elements and the exterior ends of the aforementioned lateral elements; b) the second row, includes two central joined elements, arranged in V-shape, adapted for recuperating and obliquely displacing in the direction of the free ends of the aforementioned elements, in other words in the opposite direction from that resulting from the action of the lateral elements of the first row, the part of sand not dumped into the carroting holes situated on the passage of the aforementioned elements.

12. The device of claim 11 wherein the first row includes two additional lateral elements arranged on each side of the first lateral elements and adapted for, on the one hand, recuperating and obliquely displacing, in the same direction, the part of the sand previously displaced by the aforementioned first lateral elements and not dumped into the carroting holes situated on the passage of the aforementioned elements, and, on the other hand, obliquely displacing, in the aforementioned direction, the sand situated on the part of the trajectory ranging between the exterior ends of the first lateral elements and the exterior ends of the lateral elements.

13. The device of claim 11 wherein the second row includes two distinct lateral elements arranged on each side of the corresponding central elements and adapted for recuperating and obliquely displacing, in the opposite direction, the part of the sand previously displaced by the first lateral elements then by the additional lateral elements and not dumped into the carroting holes situated on the passage of the aforementioned elements.

14. The device of claim 11 wherein all the elements form, with the axis of the frame, an angle of 45° and are symmetrical in relation to the aforementioned axis.

15. The device of claim 11 wherein the frame is connected to each lift arm by means of a connecting rod provided, on the frame side, with a pierced joint traversed by an axel connected to cross pieces of the sash of the aforementioned frame, and, on the lift arm side, with a longitudinal opening capable of permitting the longitudinal displacement of the end of the aforementioned lift arm.

16. The device of claim 11 wherein the frame includes, laterally, at the front, at the exterior of the work zone, wheels connected to offset arms.

17. The device of claim 16 wherein the wheels and are adjustable in height with respect to the frame.

18. The device of claim 11 wherein the frame includes, at the rear, wheels connected to support arms.

19. The device of claim 18 wherein the wheels and are adjustable in height with respect to the frame.

20. The device of claim 11 wherein the frame is fixed to the lift arms of a standard commercial lawnmower instead of the carrying frame of the cutting tools.
